(19) United States
(12) Patent Application Publication
(10) Pub. No.: US 2005/0260400 A1
(43) Pub. Date: Nov. 24, 2005

(54) Foam products with silane impregnated facer

(76) Inventors: Mandy B. Schweitzer, Westminster, CO (US); Steven G. Halterbaum, Highlands Ranch, CO (US); Raymond C. Swann, Kansas City, KS (US); Ralph Michael Fay, Lakewood, CO (US); Christopher James Griffin, Aurora, CO (US)

Correspondence Address: Robert D. Touslee;Johns Manville, 10100 West Ute Avenue, Littleton, CO, 80127, US

(21) Appl. No.: 10/850,517

(22) Filed: May 20, 2004

(51) Int. Cl. B32B 3/26

(52) U.S. Cl. 428/316.6; 428/543; 52/309.4

(57) ABSTRACT

Provided is a foam board with an a silane treated facer paper. The silane treated facer enhances the water resistance of the foam board, and offers outstanding resistance to delamination.

### BACKGROUND OF THE INVENTION

1. Field of the Invention

The present invention relates to a hydrophobic foam product. More particularly, the present invention relates to a foam product with an organosilane impregnated facer.

2. Description of the Related Art

The manufacture of flexible faced, rigid foam insulation boardstock, preferably polyisocyanurate foam products, is well known. For example, see U.S. Pat. Nos. 6,140,383 and 6,355,701. These foam products, because of their especially good thermal insulation properties, find extensive application in the manufacture of laminated articles for the building industry. However, providing a more weather-resistant/water-resistant product which offers better delamination characteristics is of great interest to the industry.

The foam products can be made continuously or discontinuously, for example, batchwise in a mold. The process generally involves deposition of a foam forming mixture onto a facing sheet and then allowing the foam mixture to create the foam core and hence the finished article. Particularly suitable facing sheets for such laminates, from the standpoint of their inexpensiveness and ease of handling, are cellulosic materials. The production of paper-faced rigid foams is described in many patents, for example, U.S. Pat. Nos. 3,686,047; 3,903,346; 3,940,517; 4,121,958; 4,292,363; 4,366,204; and 4,764,420. When employing a paper facer, however, the need for moisture resistance is important to the structural integrity of the overall product.

U.S. Pat. No. 5,204,176 discloses the use of polyisocyanate-impregnated cellulosic materials to form relatively rigid and strong hydrophobic sheets as siding layers for structural siding products. The sheets are said to provide weather protection, impact resistance and wind penetration resistance to a structure, and to contribute to its racking strength.

U.S. Pat. No. 5,352,510 describes the production of a rigid foam plastic faced with at least one polyisocyanate-impregnated cellulosic material. The laminate product is said to exhibit good overall properties, including superior facing sheet adhesion, dimensional stability, strength properties and insulating value.

In U.S. Pat. No. 4,764,420, there is described a laminated rigid foam panel which utilizes a laminate facing sheet of a fibrous material, such as a paper facer, having a thin layer of a substantially air and moisture impermeable polymer. The facing sheet is generally a kraft paper coated on one side with a latex emulsion of polyvinylidene chloride copolymers. This polymeric barrier film is between the foam core and the paper facer.

It is of interest to the industry, however, to provide a foam product utilizing a cellulosic facer material which can also offer excellent water resistance. Such foam products must also exhibit good overall properties and be economical. It is an object of the present invention to provide such a foam product.

### SUMMARY OF THE INVENTION

In accordance with the foregoing objectives, the present invention provides a foam board with a silane treated facer paper. The use of a silane, and preferably an organosilane such as methyltrichlorosilane, to treat the paper facer has been found to provide an excellent hydrophobicity to the facer, which gives the overall foam product good overall physical, thermal and dimensional properties, and also protects the integrity of the product in avoiding delamination of the facer from the foam core.

### DETAILED DESCRIPTION OF THE PREFERRED EMBODIMENTS

The foam product of the present invention is essentially a thermoset foam laminate, whose foam core is covered or faced by at least one silane treated cellulosic material. The product is prepared by conventional methods involving bringing at least one such silane treated cellulosic or paper sheet into contact or close proximity with a foam forming mixture on a conveyor, and thereafter conveying together the composite of sheet and foamable mixture while foaming the mixture to produce the final foam laminate product.

Any cellulose material may be treated with a silane in the formation of the facing sheets of the present invention. Examples are cellulosic fiber materials such as bleached or unbleached kraft paper or linerboard, or other paper products, as is known in the industry. Any cellulosic material having sufficient porosity for takeup of the silane materials may be used. Paper products, such as kraft paper, are preferred. Such a suitable kraft paper generally has a basis weight of from 15-200 lbs/3000 sq. ft. The cellulosic facer material can also be reinforced with a reinforcing fiber, preferably glass fiber. The amount of reinforcing fiber can vary, but is preferably in the range of from 10-15 wt %, and most preferably in an amount of about 12 wt %.

The silane material used to treat the paper facer can be any suitable silane material. Such materials are commercially available. Silanes are compounds containing a hydrogen-silicon bond, and those of commercial significance include organic silanes, inorganic silanes and polymeric siloxanes (silicones). Mixtures of silanes can be used. Organosilanes are the most preferred compounds for the present invention. Among the organosilanes of preference are the chlorosilanes. Specific examples of suitable chlorosilanes include methyldichlorosilane, trimethylchlorosilane, dimethyldichlorosilane, methyltrichlorosilane, or any mixture thereof. Substituted silane derivatives may also be used. Generally, a suitable hydrocarbon solvent is employed when treating the paper facer with the organosilane material to aid in impregnating the facer material

The silane material is applied in any manner conducive to thorough impregnation of the paper facer material. For example, the silane material may be applied to one or both sides of the facer material by dipping, coating, spraying, brushing or by any other convenient art-recognized technique. Once impregnated, the paper facer is then suitably subjected to temperature and/or pressure sufficient to effect a chemical bond between the organosilane and the cellulose structure, and remove any excess solvent.

In one preferred embodiment, a roll of paper facer material is run through a trough containing an organosilane material and solvent. Once the paper material leaves the trough, the hydrocarbon solvent is removed, and the chemical bonding is effected. Preferably, the impregnated paper facer is then wound onto another roll, which facilitates its use in the process for preparing the final foam product.

In another embodiment, a pressure treatment tank can be used in a procedure for impregnating an entire paper facer roll with the silane material. Generally, the roll of facer paper is placed into a pressure tank, which is then sealed. Silane material e.g., an organochlorosilane, and solvent is then pumped into the tank and a pressure applied within the tank. The pressure is maintained until the roll of facer paper is impregnated. Once impregnation is complete, a vacuum can be used to remove the excess solvent and organosilane material. The impregnated paper roll can then be removed from the tank, cured or bonded, and then used in a process for preparing the ultimate foam product.

The foam core of the product faced with the impregnated facer may be formed from any available foamable composition which has the capacity of being foamed on a moving substrate. Examples of these materials are polystyrene, polyvinyl chloride, polyethylene, polypropylene, polyacrylonitrile, polybutadiene, polyisoprene, polytetrafluoroethylene, polyesters, melamine, urea, phenol resins, silicate resins, polyacetal resins, polyepoxides, polyhydantoins, polyureas, polyethers, polyurethanes, polyisocyanurates, polyimides, polyamides, polysulphones, polycarbonates, and copolymers and other polymeric types. While the foams may be rigid, semi-rigid or flexible, the present invention finds greatest utility when the foamed product is of the rigid type used in constructional articles, especially rigid polyisocyanurate foams.

In the manufacture of the rigid cellular polyurethanes and polyisocyanurates, two preformulated components, commonly called the A-component and the B-component, are generally employed. Typically, the A-component contains the isocyanate compound that must be reacted with the polyol of the B-component to form the foam, and the remaining foam-forming ingredients are distributed in these two components or in yet another component or components. All components are mixed and deposited onto the advancing facing sheet.

Any organic polyisocyanate can be employed in the preparation of the rigid polyisocyanurate foams, which are the preferred forms for the foamed products of the present invention. The organic polyisocyanates which can be used include aromatic, aliphatic and cycloaliphatic polyisocyanates and combinations thereof. Such polyisocyanates are described, for example, in U.S. Pat. Nos. 4,795,763, 4,065,410, 3,401,180, 3,454,606, 3,152,162, 3,492,330, 3,001,973, 3,394,164 and 3,124,605, all of which are incorporated herein by reference.

Representative of the polyisocyanates are the diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; the triisocyanates such as 4,4′,4″-triphenylmethane-triisocyanate, polymethylenepolyphenyl isocyanate, toluene-2,4,6-triisocyanate; and the tetraisocyanates such as 4,4′dimethyldiphenylmetlhane-2,2′,5,5″-tetraisocyanate.

Prepolymers may also be employed in the preparation of the foams of the present invention. These prepolymers are prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181 (1927). These compounds and their methods of preparation are well known in the art. The use of any one specific active hydrogen compound is not critical hereto, rather any such compound can be employed in the practice of the present invention.

Preferred isocyanates used according to the present invention include Mondur 489 (Bayer), Rubinate 1850 (ICI), Luprinate M70R (BASF) and Papi 580 (Dow). Isocyanate indices greater than about 200 are preferred, particularly from about 225 to about 325. In addition to the polyisocyanate, the foam-forming formulation also contains an organic compound containing at least 1.8 or more isocyanate-reactive groups per molecule. Preferred isocyanate-reactive compounds are the polyester and polyether polyols. Such polyester and polyether polyols are described, for example, in U.S. Pat. No. 4,795,763.

The polyester polyols useful in the invention can be prepared by known procedures from a polycarboxylic acid or acid derivative, such as an anhydride or ester of the polycarboxylic acid, and a polyhydric alcohol. The acids and/or the alcohols may be used as mixtures of two or more compounds in the preparation of the polyester polyols.

The polycarboxylic acid component, which is preferably dibasic, may be aliphatic, cycloaliphatic, aromatic and/or heterocyclic and may optionally be substituted, for example, by halogen atoms, and/or may be unsaturated. Examples of suitable carboxylic acids and derivatives thereof for the preparation of the polyester polyols include: oxalic acid; malonlic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester.

Any suitable polyhydric alcohol may be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than about 20 carbon atoms are highly satisfactory. The polyols optionally may include: substituents which are inert in the reaction, for example, chlorine and bromine substituents, and/or may be unsaturated. Suitable amino alcohols, such as, for example, monoethanolamine, diethanolamine, triethanolamine, or the like may also be used. Moreover, the polycarboxylic acid(s) may be condensed with a mixture of polyhydric alcohols and amino alcohols.

Examples of suitable polyhydric alcohols include: ethylene glycol; propylene glycol-(1,2) and -(1,3); butylene glycol-(1,4) and -(2,3); hexanediol-(1,6); octane diol-(1,8); neopentyl glycol; 1,4-bishydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; alpha.-methyl-glucoside; diethylene glycol; triethylene glycol; tetraethylene glycol and higher polyethylene glycols; dipropylene glycol and higher polypropylene glycols as well as dibutylene glycol and higher polybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Particularly preferred polyester polyols include Stepanpol PS2352 (Stepan) and Terate 2541 (Hoechst Celanese). Preferred amounts of the polyester polyols are consistent with isocyanate indices greater than 200, preferably between about 225 and 325.

Polyether polyols useful according to the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators may be alkoxylated to form useful polyether polyols. Thus, for example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol would determine the amount of alkylene oxide used to react with the initiator. The polyether polyol may be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight polyether polyols can also be employed.

Any suitable blowing agent can be employed in the foam compositions of the present invention. In general, these blowing agents are liquids having a boiling point between minus 50° C. and plus 100° C. and preferably between 0° C. and 50° C. The preferred liquids are hydrocarbons or halohydrocarbons such as chlorinated and fluorinated hydrocarbons. Suitable blowing agents include HCFC-141b (1-chloro-1,1-difluoroethane), HCFC-22 (monochlorodifluoromethane), HFC-245fa (1,1,1,3,3-pentafluoropropane), HFC-134a (1,1,1,2-tetrafluoroethane), HFC-365mfc (1,1,1,3,3-pentafluorobutane), cyclopentane, normal pentane, isopentane, LBL-2(2-chloropropane), trichlorofluoromethane, CCl₂, FCClF₂, CCl₂, FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof.

The foams also can be produced using a froth-foaming method, such as the one disclosed in U.S. Pat. No. 4,572,865. In this method, the frothing agent can be any material which is inert to the reactive ingredients and is easily vaporized at atmospheric pressure. The frothing agent advantageously has an atmospheric boiling point of −50° to 10° C., and includes carbon dioxide, dichlorodifluoromethane, monochlorodifluoromethane, trifluoromethane, monochlorotrifluoromethane, monochloropentafluoroethane, vinylfluoride, vinylidenefluoride, 1,1-difluoroethane, 1,1,1-trichlorodifluoroethane, and the like. A higher boiling blowing agent is desirably used in conjunction with the frothing agent. The blowing agent is a gaseous material at the reaction temperature and advantageously has an atmospheric boiling point ranging from about 10° to 80° C. Suitable blowing agents include trichloromonofluoromethane, 1,1,2-trichloro-1,2,2-trifluoroethane, acetone, pentane, and the like. In the froth-foaming method, the foaming agents, e.g., trichlorofluoromethane blowing agent or combined trichlorofluoromethane blowing agent and dichlorodifluoromethane frothing agent, are employed in an amount sufficient to give the resultant cured foam the desired bulk density which is generally between 0.5 and 10, preferably between 1 and 5, and most preferably between 1.5 and 2.5, pounds per cubic foot. The foaming agents generally comprise from 1 to 30, and preferably comprise from 5 to 20 weight percent of the composition. When a foaming agent has a boiling point at or below ambient, it is maintained under pressure until mixed with the other components. Alternatively, it can be maintained at subambient temperatures until mixed with the other components. Mixtures of foaming agents can be employed.

Catalysts are advantageously employed in the foam-forming mixture for accelerating the isocyanate-hydroxyl reaction. Such catalysts include organic and inorganic acid salts and organometallic derivatives of various metals, as well as phosphine and tertiary organic amines. In the preparation of the polyisocyanurate rigid foams, any catalysts known to catalyze the trimerization of isocyanates to form isocyanurates, and to catalyze the reaction of isocyanate groups with hydroxyl groups to form polyurethanes, can be employed. The catalysts generally comprise from about 0.1 to 20, and preferably from 0.3 to 10, weight percent of the total foam-forming composition.

Any suitable surfactant can be employed in the foams of this invention, including silicone/ethylene oxide/propylene oxide copolymers. Examples of surfactants useful in the present invention include, among others, polydimethylsiloxane-polyoxyalkylene block copolymers available from Witco Corporation under the trade names “L-5420”, “L-5340”, and Y10744; from Air Products under the trade name “DC-193”; from Goldschmidt under the name, Tegostab B84PI; and Dabco DC9141. Other suitable surfactants are those described in U.S. Pat. Nos. 4,365,024 and 4,529,745. Generally, the surfactant comprises from about 0.05 to 10, and preferably from 0.1 to 6, weight percent of the foam-forming composition.

Other additives may also be included in the foam formulations. Included are processing aids, viscosity reducers such as 1-methyl-2-pyrrolidinone, propylene carbonate, nonreactive and reactive flame retardants, such as tris(2-chloroethyl)-phosphate, dispersing agents, reinforcing agents, plasticizers, mold release agents, stabilizers against aging and weathering, compatibility agents, fungistatic and bacteriostatic substances, dyes, fillers and pigments, and other additives. The use of such additives is well known to those skilled in the art.

One preferred method of utilizing the isocyanate-impregnated facers involves their application on a restrained-rise production line.

In the traditional restrained rise process, isocyanate (“Component A”) is used as received. Component A is supplied by pump to a metering unit, or a metering pump. A premix (“Component B”) containing polyol, flame retardant, catalyst and surfactant is prepared according to a defined formulation in a mix tank. Component B and a blowing agent are also supplied by a pump to a metering unit, or a metering pump. The metering pumps boost the pressure generally to 2000 to 2500 psi and control the flow of Components A, B and blowing agent to a precise ratio as determined by the desired chemistry. The pumps deliver Components A, B and blowing agent to at least one foam mixhead. Inside the mixhead, the Components A, B and a blowing agent are impinged against each other at high pressure, which results in intimate mixing of the components.

The mixed chemicals exit the mixhead and are dispensed onto a moving bottom facing sheet in a plurality of discrete, liquid streams, in a quantity depending on the type and thickness of desired final boardstock product. The facing sheet carrying the chemical streams then enters a pressure laminator. The spacing, or gap, between the top and bottom platens of the laminator is set to approximately the final desired thickness of boardstock. The laminator temperature is adjusted typically to about 120 to 150° F. to insure that no heat is lost from the reacting, exothermic chemical mix, and to insure that the facings adhere well to the rising foam.

The mixed chemicals begin to react in about 5 to 10 seconds following mixing, expanding about 35 to 40 times in volume in the laminator and completing reaction in about 35 to 45 seconds. Laminator speed is adjusted to insure that complete reaction occurs within the pressure section of the laminator. The reaction rate is adjusted by catalyst modification to optimize chemical mixture “flow.” Flow is a property of the reacting, rising foam by which expansion is controlled in such a manner that the foam properly expands both upward and sideways to fully fill the moving cavity defined by the laminator. This reactivity adjustment is essential to control both the overall properties of the final product and the cost of manufacture. Improper flow results in poor foam cell geometry which can deteriorate physical, thermal and flammability properties, and causes excessive densification of foam layers in contact with facings.

Rigid boardstock, with facing firmly attached, exits the laminator. This boardstock is trimmed to the desired final width and length. Finished product is conveyed to packaging equipment.

Another known process for making flexible faced, rigid polyisocyanurate foam insulation boardstock is the free rise process. In this process, chemical laydown or distribution is accomplished through the use of a pair of matched, precision metering rolls. Chemicals are dispensed just upstream of the metering rolls. The gap between the rolls is adjusted to approximately 1/35 to 1/40 of the desired finished thickness of the boardstock. This small gap causes the dispensed chemical to form a “chemical bank” against the metering roll, forcing the chemical to spread across the full width of the bottom facer. A thin layer of mixed foam chemicals (approximately 1/35 to 1/40 of the desired finished thickness of the boardstock) is uniformly spread between the top and bottom facers. This composite then moves into a heated oven where the foam reaction is completed. Foam expands 35 to 40 times in volume and becomes sufficiently rigid for further processing. Final foam thickness is controlled by precision adjustment of the metering rolls. No mechanical restraint is utilized for thickness control, as with the restrained-rise process.

The free rise process does not require chemical flow. Dispensed and metered chemicals need only expand in the thickness dimension and not in the width dimension since the original laydown already accomplishes full width application. By removing the need for flow, catalyst adjustments are made only to achieve complete reaction at the desired line speed without the negative impact of “locking up” the foam system. The free rise process is capable of speeds in excess of 250 feet/min.

An additional benefit of the free rise process is that density control is achieved within more efficient limits. Since sideways flow of expanding chemical does not occur, densification at the foam/facer interface is minimized. Density spreads of 1.70 lb/ft.³ for core foam density and 1.75 lb/ft.³ for IPD are routinely achieved.

The most preferred method of preparing the foamed product employing the facer of the present invention, however, is that described in U.S. Pat. Nos. 6,140,383 and 6,355,701, both of which are hereby incorporated by reference in their entirety. In the process, a foam forming mixture of polyisocyanurate is applied to a facing material, spread in the direction of, and preferably along the entire width of, the facing material, e.g., by using a metering device, and the facing material with applied foam forming mixture is then conveyed into a laminator which comprises a gap for foam expansion. The mixture is allowed to foam and expand to fill the gap within the laminator, and then the foam is cured. Optionally, the facing material is attached to both sides of the core or polyisocyanurate foam, as is possible when using the facing material of the present invention with any method for preparing the foam product.

The foam products of the present invention can be used in various ways as a building material, and particularly for insulation purposes. Using conventional fastening means, such as chemical fasteners (adhesives) or a combination of chemical fasteners and mechanical fasteners, the foam products can be suitably mounted to a building framework. The silane e.g., organosilane, impregnated facer provides excellent waterproof properties and also provides outstanding resistance to delamination and to changes in dimensions with aging and exposure to adverse conditions. Thus, the foam products would be of particular use in various adverse weather conditions without the need for additional protection, such as an additional overcoating or overlay.

The present invention is further illustrated by the following example, which is meant to be illustrative, and in no way limiting.

### EXAMPLE

A methyltrichlorosilane/pentane mixture was held in a separate tank from the pressure-treatment tank. A roll of paper facer ranging from 1 to 4 ft. in diameter was loaded into the pressure tank and closed. The pressure tank was then purged with nitrogen and air removed. The tank was at zero atm prior to the pumping of the methyltrichlorosilane/pentane mixture into the pressure tank. The methyltrichlorosilane/pentane mixture was pumped into the pressure tank until the pressure gauge reached 250 psi. A pressure of 250 psi was maintained for 2 hours. A vacuum was then used to remove the excess methyltrichlorosilane/pentane and the facer roll was unloaded.

The facer was tested for water absorption via a 2-hour water absorption test. One set of uncoated facer samples showed 160% by weight water absorption. Sets of coated facer achieved 100% and less by weight water absorption. This demonstrated that the methyltrichlorosilane decreases the amount of water uptake by the sample.

While the invention has been described in detail and with reference to specific embodiments thereof, it will be apparent to one skilled in the art that various changes and modifications can be made therein without departing from the spirit and scope thereof.

1. A foam board comprising a rigid foam having two major faces and a cellulosic facing material on at least one of the major faces, with the cellulosic facing material having been treated with a silane.

2. The foam board of claim 1, wherein the foam is a polyisocyanurate foam.

3. The foam board of claim 1, wherein the facing material is a paper facing material.

4. The foam board of claim 3, wherein the paper facing material is glass fiber reinforced.

5. The foam board of claim 4, wherein the glass fiber reinforcement content of the paper facing is from 10 to 15% by weight.

6. The foam board of claim 1, wherein the facing material treated with the silane is on both major faces of the foam.

7. The foam board of claim 1, wherein the silane is impregnated in the facer material by means of a pressure treatment, or by spraying, dipping or brush application.

8. The foam board of claim 1, wherein the silane comprises an organosilane.

9. The foam board of claim 1, wherein the silane comprises a chlorosilane.

10. The foam board of claim 1, wherein the silane comprises methyldichlorosilane, trimethylchlorosilane, dimethyldichlorosilane, methyltrichlorosilane, or a mixture thereof.

11. A roll of silane treated paper.

12. The roll of silane treated paper of claim 11, wherein the paper in the roll was treated by means of a pressure treatment, spray, dip or brush application.

13. The roll of treated paper of claim 11, wherein the silane used in treating the paper comprised an organosilane.

14. The roll of treated paper of claim 11, wherein the silane used in treating the paper comprised methyldichlorosilane, trimethylchlorosilane, dimethyldichlorosilane, methyltrichlorosilane, or a mixture thereof.
